(19) United States
(12) Patent Application Publication
(10) Pub. No.: US 2013/0132544 A1
(43) Pub. Date: May 23, 2013

(54) PRECISE GEOLOCATION FOR CONTENT CACHING IN EVOLVED PACKET CORE NETWORKS

(71) Applicants: Suresh Krishnan, Montreal (CA); Alan Kavanagh, Montreal (CA)

(72) Inventors: Suresh Krishnan, Montreal (CA); Alan Kavanagh, Montreal (CA)

(73) Assignee: TELEFONAKTIEBOLAGET L M ERICSSON (PUBL), Stockholm (SE)

(21) Appl. No.: 13/304,012

(22) Filed: Nov. 23, 2011

(51) Int. Cl. G06F 15/173

(52) U.S. Cl. 709/223

(57) ABSTRACT

A network element in a network is provided. The network element includes a receiver that receives a content request message. The received content request message indicates content to be transmitted to a device. The network element includes a processor in communication with the receiver. The processor generates a modified content request message by inserting identification data into the content request message. The identification data identifies at least one of a plurality of network nodes in the network. The network element includes a transmitter that transmits the modified content request message to a content distribution network server. The receiver further receives a redirect message that is based on the transmitted modified content request message. The redirect message identifies that a one of the plurality of network nodes is a cache location storing the indicated content.

### TECHNICAL FIELD

The present invention relates to information retrieval, and in particular to a method and system for geo-locating a device to a cache location.

### BACKGROUND OF THE INVENTION

The evolved packet core (EPC) has been gaining popularity over previous mobile generation network architectures, e.g., 2G and 3G, as a technology that allows for the implementing of new value added services and enablement of new applications. In particular, the previous mobile generation network architectures, e.g., 2G and 3G, rely on two separate sub-domains for routing packets: a circuit-switched sub-domain for voice packets and a packet-switched sub-domain for data packets. However, using two separate domains for routing packets requires separate processing and switching of voice and data. This arrangement adds to the cost of the network and limits functionality.

EPC is an all internet protocol (IP) network architecture that converges the framework for packet-based real-time and non-real-time services, i.e. converges data and voice onto the same routing domain. For example, EPC has a unified single IP domain for processing and switching of mobile voice and data traffic while maintaining quality requirements for real-time services. In particular, EPC provides an all-IP mobile core for Long Term Evolution (LTE) technologies that allows for end-to-end IP service across the LTE network, e.g., voice traffic is treated as an IP-based network application with specific quality/performance requirements.

The EPC may be linked or connected to content distribution networks (CDNs) that provide content to users in the EPC. In particular, a CDN includes an assortment of cache servers placed at various locations within the CDN in which the assortment of cache servers cache or replicate content provided by a content provider. The use of cache servers allows the CDN and/or content provider to handle abrupt increases in content requests by referring the content requesters to one of the cache servers. For example, assume a sudden surge in web content requests for a specific video has been received by the content provider or a mobile network operator. If the content provider handles all the content requests, the content provider may become so inundated that the content provider will have to temporarily take the requested content offline, e.g., make the content temporarily unavailable to users. As such, the content provider may have an agreement with a CDN that allows the content provider to refer the content request to a cache server such that the cache server provides the requested content to the user.

However, the CDN refers the content requester to the closest cache server in the CDN. In particular, the closest cache server to an EPC is typically an edge cache server in the CDN. For example, all users in the EPC may connect to the CDN via a packet data network gateway (P-GW) in which all users will likely be referred to the same cache server in the CDN. The P-GW serves as the internet protocol (IP) gateway for all users communicating via a specific EPC. As such, all users in the EPC are likely to be sent the same cache server in the CDN even though geographically closer caches in the EPC may be available, thereby increasing network inefficiency, wasting networking resources, adding to network latency, etc.

Accordingly, it is desirable to have a system and method that allows for the distribution of caches throughout the EPC and allows CDNs to make efficient use of the caches in the EPC.

### SUMMARY OF THE INVENTION

The present invention advantageously provides a method and system for accurately locating a mobile device to a geographically efficient cache location.

According to one embodiment a network element in a network includes a receiver that receives a content request message. The received content request message indicates content to be transmitted to a device. The network element includes a processor in communication with the receiver. The processor generates a modified content request message by inserting identification data into the content request message. The identification data identifies at least one of a plurality of network nodes in the network. The network element includes a transmitter that transmits the modified content request message to a content distribution network server. The receiver further receives a redirect message based on the modified content request message. The redirect message identifies that a one of the plurality of network nodes is a cache location storing the indicated content.

According to another embodiment, a system is provided in which the system includes a server having a receiver. The receiver receives a modified content request message that indicates content to be downloaded to a device. The modified content request message includes identification data corresponding to at least one network node in a network. The server includes a processor in communication with the receiver. The processor evaluates the modified content request message to determine the identification data. The processor determines a first cache location based at least in part on the identification data. The first cache location is a network node that stores the indicated content in which the first cache location is geographically closer to the device than other cache locations at other network nodes.

According to yet another embodiment, a method is provided for geo-locating a device to a cache location. The method includes receiving a content request message that indicates content to be transmitted to a device. The method includes generating a modified content request message by inserting identification data into the content request message. The identification data corresponds to at least one node in the network. The method includes transmitting the modified content request message and forwarding a redirect message generated in response to the transmitted modified content request message. The redirect message directs the device to one of a plurality of cache locations storing the indicated content. The direction being based at least in part on geographic location.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a geo-location system constructed in accordance with the principles of the present invention;

FIG. 2 is a block diagram of another view of the geo-location system constructed in accordance with the principles of the present invention;

FIG. 3 is a flowchart of an exemplary packet enrichment process of the present invention;

FIG. 4 is a flowchart of an exemplary redirection process of the present invention;

FIG. 5 is a flowchart of an exemplary content request process of the present invention; and

FIG. 6 is a block diagram of an example of the geo-location system showing mobile device mobility constructed in accordance with the principles of the present invention.

### DETAILED DESCRIPTION OF THE INVENTION

The present invention advantageously provides a system and method that allows geo-location of a device to a cache. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

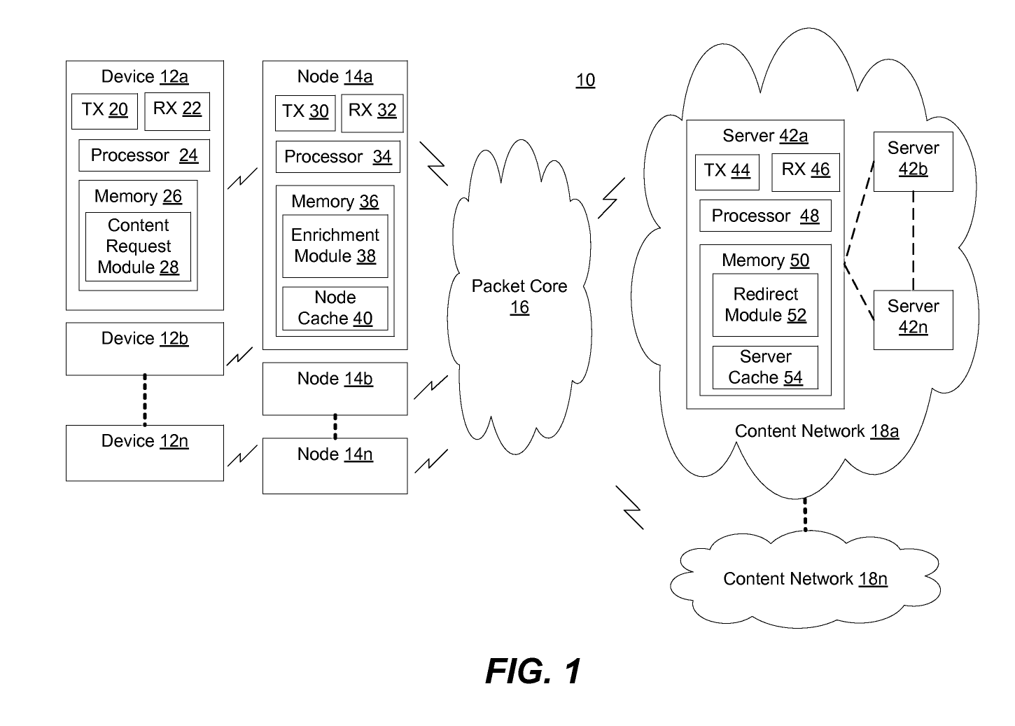

Referring now to the drawing figures in which like reference designators refer to like elements there is shown in FIG. 1 an exemplary geo-location system constructed in accordance with the principles of the present invention and designated generally as “10.” System 10 may include one or more devices 12a to 12n (collectively referred to as “device 12”), one or more nodes 14a to 14n (collectively referred to as “node 14”), one or more packet cores (referred to as “packet core 16”), and one or more content networks 18a to 18n (collectively referred to as “content networks 18”).

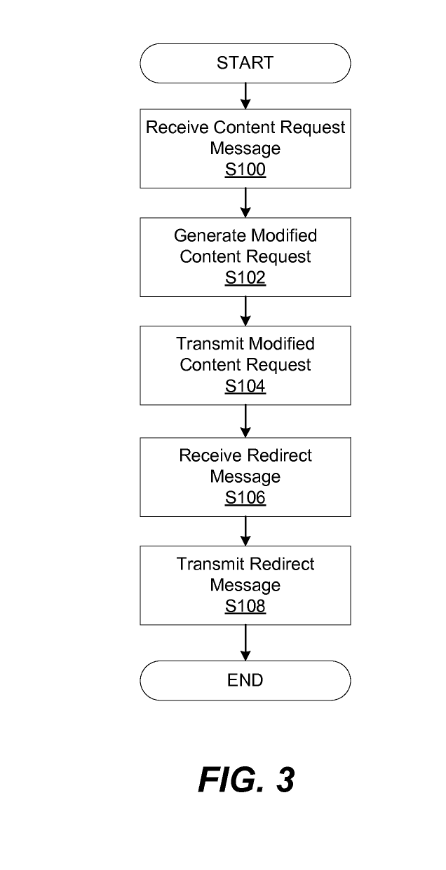

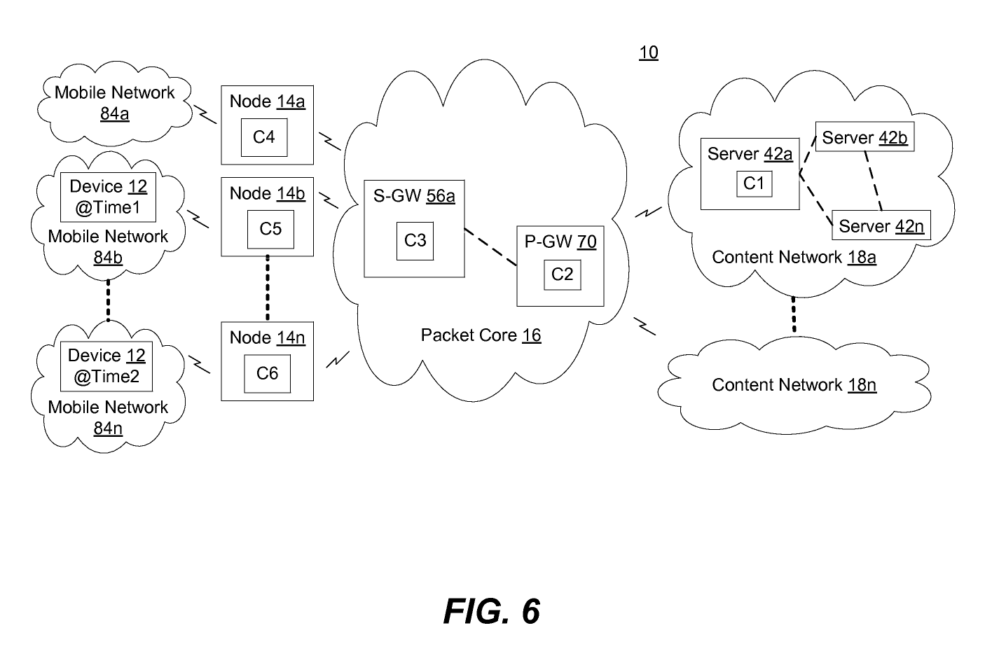

Device 12 may include a transmitter 20 and receiver 22 for communicating with node 14 via a communications network using communication protocols known in the art, e.g., using internet protocols. For example, the communications network may be a mobile communications network, as described in detail below with respect to FIG. 6. Device 12 may include a processor 24 such as a central processing unit (CPU) for performing device functions described herein. Device 12 may include memory 26 that stores content request module 28, among other modules. In particular, memory 26 may include non-volatile and volatile memory. For example, non-volatile memory may include a hard drive, flash memory, memory stick and the like. Also, volatile memory may include random access memory and others known in the art. Memory 26 may store program instructions such as those for content request module 28. For example, content request module 28 includes instructions, which when executed by processor 24, cause processor 24 to perform the content request process, discussed in detail with reference to FIG. 3. Memory 26 may store content such as audio and video, among other digital content. Device 12 may include input mechanism (not shown) that allow user of device 12 to initial the content request process, e.g., input buttons or voice activated button, among other inputs mechanism types. Device 12 may include mobile devices, computers, laptops and personal digital assistants, among other devices capable of transmitting and receiving internet protocol (“IP”) packets.

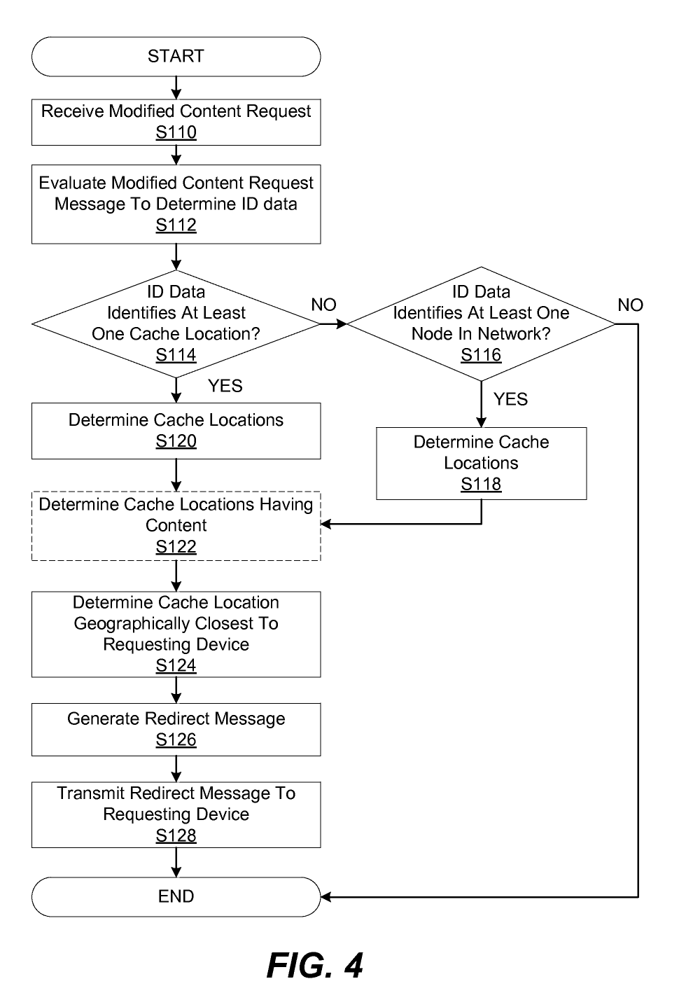

Node 14 may include transmitter 30, receiver 32, processor 34 and memory 36 in communication with each other. In particular, transmitter 30, receiver 32, processor 34 and memory 36 may generally correspond to the components in device 12, with size and performance being adjusted based on design needs, while providing the functionality described herein with respect to node 14. For example, transmitter 30 and receiver 32 may provide transmission and reception of data communications to/from device 12 and packet core 16, among other communication devices, gateways and servers. Memory 36 may store enrichment module 38 and node cache 40, among other modules and caches. Enrichment module 38 performs the process of modifying a content request message or packet. For example, enrichment module 38 includes instructions, which when executed by processor 38, cause processor 34 to perform the enrichment or modifying process, discussed in detail below with reference to FIG. 4. In one embodiment, node 14 is a base station such as a Long Term Evolution (LTE) eNodeB.

Node cache 40 may store any digital content such as static content and streaming media, among other digital content. In particular, static content may refer to content that does not change very often. For example, static content may include static hyper-text markup language (HTML) pages, images, documents, software patches, audio files and video files, among other digital content. Streaming content may refer to digital content such on-demand multimedia digital content and content that is presented on device 12 display while being delivered by node 14 or other devices, servers and gateways.

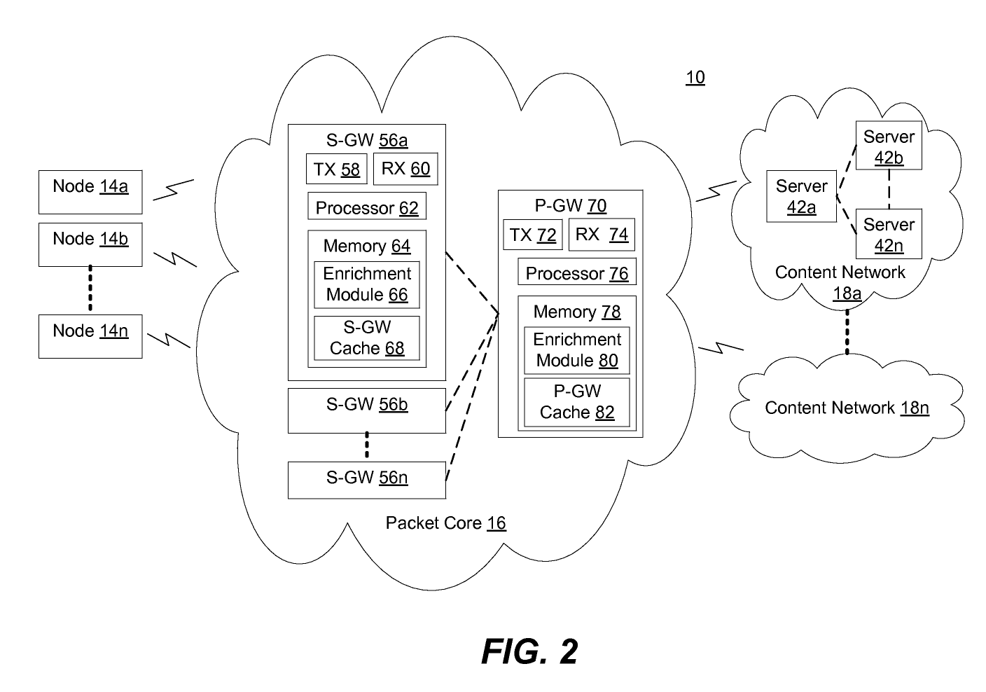

Packet core 16 may be an IP-based core network. For example, packet core 18 may be an evolved packet core (EPC) network that is based on end-to-end IP based transmission in and out of EPC network, e.g., all-IP based. For example, data and voice may be communicated through EPC via IP packets. Packet core 18 is discussed in detail below with respect to FIG. 2.

Content network 18 may be a content distribution network (CDN) that provides caches of content throughout content network 18. In particular, content network 18 may include one or more servers 42a to 42n (collectively referred to as “server 42”). Server 42 may include transmitter 44, receiver 46, processor 48 and memory 50, among other components. In particular transmitter 44, receiver 46, processor 48 and memory 50 may generally correspond to the components in device 12, with size and performance being adjusted based on design needs, while providing the functionality described herein with respect to server 42. For example, transmitter 44 and receiver 46 may provide transmission and reception of data communications to and from packet core 16, other content networks and content provider networks, among other networks and devices.

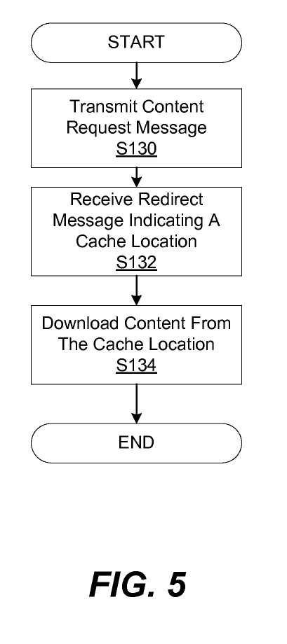

Memory 50 may include redirect module 52 and server cache 54, among other modules and caches. Redirect module 52 performs the process of geo-locating device 12 with the geographically closest cache. For example, redirect module 52 includes instructions, which when executed by processor 48, cause processor 48 to perform the redirect process, discussed in detail below with reference to FIG. 5. Server cache 54 may store content similar to content stored in node cache 40.

FIG. 2 illustrates another view of exemplary geo-location system 10. In particular, packet core 16 includes one or more serving gateways 56a to 56n (collectively referred to as “S-GW 56”). In particular, serving gateway 56 may route and forward user data packets. S-GW 56 may include transmitter 58, receiver 60, processor 62 and memory 64, among other components. Transmitter 58, receiver 60, processor 62 and memory 64 may generally correspond to the components in device 12, with size and performance being adjusted based on design needs, while providing the functionality described herein with respect to gateway 56. For example, transmitter 58 and receiver 60 may provide transmission and reception of data communications to and from node 14 and packet data network gateway (described below), among other packet core 16 devices, servers and gateways. Memory 64 may include enrichment module 66 and S-GW cache 68, among other modules and caches. Enrichment module 66 performs the process of modifying a content request message or packet. For example, enrichment module 66 includes instructions, which when executed by processor 62, cause processor 62 to perform the enrichment process, discussed in detail below with reference to FIG. 4. S-GW cache 68 may include content similar to content stored in node cache 40.

Packet core 16 may include packet distribution network gateway 70 (referred to as “P-GW”). In particular, P-GW may provide connectivity to external data communication networks such as content network 18. P-GW may act as a point of entrance and exit of traffic for the packet core 18 based network. P-GW 70 may include transmitter 72, receiver 74, processor 76 and memory 78, among other gateway components. Transmitter 72, receiver 74, processor 76 and memory 78 may generally correspond to the components in device 12, with size and performance being adjusted based on design needs, while providing the functionality described herein with respect to P-GW 70. For example, transmitter 72 and receiver 74 may provide transmission and reception of data communications to and from S-GW 70 and content network 18, among other networks and packet core 16 devices. Memory 78 may includes enrichment module 80 and P-GW cache 82. Enrichment module 80 performs the process of modifying a content request message or packet. For example, enrichment module 80 includes instructions, which when executed by processor 76, cause processor 76 to perform the enrichment process, discussed in detail with reference to FIG. 4. P-GW cache 82 may include content similar to content stored in node cache 40. While node 14, S-GW 56 and P-GW 70 may each include an enrichment module, the enrichment process illustrated in FIG. 4 may be performed by one or more of these elements. For example, the enrichment process may be performed only by P-GW 70, node 14 or S-GW 56. Alternatively, the enrichment process may be performed by any combination of devices, gateways and servers capable of performing the enrichment process of FIG. 4. For example, the enrichment process may be performed by the intermediate network elements located logically between device 12 and server 42. Continuing the example, the enrichment process may be performed by node 14, serving device 12, and by P-GW 70. The enrichment process is discussed in detail below with reference to FIG. 4.

The cache locations in packet core 18 based network may be distributed based at least in part on a location criteria. For example, the location criteria may indicate that network elements routing high amounts of network traffic are to have a corresponding cache location. As another example, the location criteria may indicate that one or more anchor points in the packet core 18 based network each have a cache location. In particular, one or more network elements that provide anchor points for other network elements. Continuing the example, S-GW 56 may provide an anchor point for device 12 hand-over from node 14a to node 14b such that data communications from device 12 will continue to be routed through S-GW 56. The one or more anchor points such as node 14, S-GW 56 and P-GW 70 may each have a cache location that stores content. The location criteria may be based at least in part on a number of devices that communicate with the network via a specific network element. For example, a large number devices 12 may communicate via node 14a, S-GW 56b and P-GW 70 such that each of these network elements has corresponding cache locations. Node 14a may have node cache 40, S-GW 56b may have S-GW cache 68 and P-GW70 may have P-GW cache 82 while other network elements may not have corresponding cache locations. The location criteria may be based at least in part on the network architecture employed in system 10. Other location criteria may be used to determine the placement of cache location within the packet core 18 based network such as criteria used in content distribution networks.

Moreover, the specific content stored in each cache location may be based on a caching criteria. In particular, the content stored in a cache location in the packet core 18 based network may be based on the frequency at which the specific content has been previously requested. For example, the number of requests (X) for a specific video may be higher than the number of other requests (Y) for other content such that the specific video will be stored at a cache location closer to device 12 than cache locations storing the other content, X and Y being respective whole numbers. The content stored in the cache location may be periodically updated such that sudden demands for specific content are taken into account. Other caching criteria may be incorporated such as criteria used in determining cache locations in content distribution networks.

An exemplary enrichment process for facilitating geo-location of device 12 to a cache location is described with reference to FIG. 3. Device 12 initiates the enrichment process by transmitting a content request message to server 42. As the content request message is being routed toward server 42, the content request message may be intercepted or received by one or more network elements, e.g., a network element determines the content request message is received (Step S100). For example, the intercepting network element may be node 14, S-GW 56 or P-GW 70, among other network elements located logically between device 12 and server 42. The network element modifies the content request message to generate a modified content request message (Step S102). In particular, the network element may generate the modified content request message by inserting identification data into the received content request message, e.g., processor inserts identification data into the content request message. The identification data may correspond to one or more network elements. For example, the identification data may include a cache location and/or identity of at least one network element, among other data that may be used by server 42 to determine a cache location or to identify at least one network element. The identification data may be inserted into the content request message as an additional header in the message.

In particular, the identification data may correspond to the network element performing the enrichment process. For example, as the content request message is routed to server 42, node 14 may enrich the content request or modified content request message with identification data corresponding to node 14 or to another network element. In particular, node 14 may insert an IP address corresponding to node 14 or another network element. Alternatively, node 14 may determine whether node 14 has a cache, e.g., node cache. If node 14 has node cache 40, node 14 may insert a uniform resource locator (URL) corresponding to node cache 40 into the content request message. If node 14 does not have node cache 40, node 14 forwards content request message according to network communication protocols without performing the enrichment process. The modified content request message from node 14 may be received at P-GW 70, in which P-GW 70 performs the enrichment process on the previously modified content request message, i.e., enriches the previously modified content request message with identification data corresponding to P-GW 70. The enrichment process may be performed by one or more networks elements.

The enrichment process may be performed by one or more network elements. For example, P-GW 70 may generate the modified content request message by inserting identification data into the content request message. The identification data may correspond to one or more network elements and/or may correspond to the element performing enrichment. Continuing the example, P-GW 70 may insert identification data corresponding to node 14, S-GW 56 and P-GW 70 such that the modified content request message contains information of several network elements. In particular, the one network element generating the modified content request message may interrogate a management node (not shown) that provides information corresponding to several network elements in system 10. For example, the identification data may include an IP address of node 14, S-GW 56 and P-GW 70, among other network elements. The identification data may include a uniform resource locator (URL) designating some or all cache locations located in system 10. As another example, P-GW 70 may insert identification data corresponding only to P-GW 70 such that the content request message is enriched only with identification data corresponding to P-GW 70, i.e., corresponding to the network element performing the enrichment. In particular, one or more of the network elements that route or forward the content request message toward server 42 may each enrich the content request message (or already modified content request message) with identification data corresponding to network element performing the forwarding.

The order in which the identification data corresponding to one or more forwarding network elements is inserted may be maintained. In particular, inserted identification data may be stacked such that first inserted identification data is located at the bottom of the stack, i.e., at the bottom of identification data stack in the modified content request message. If the forwarding network element does not have a cache location and/or the indicated content stored, the particular forwarding network element may not insert any corresponding identification data, e.g., the forwarding network element continues to route or forward the content request message via known communication protocols without modifying the content request message.

The network element performing the enrichment process may transmit the modified content request message toward server 42, e.g., toward content distribution network server, according to network communication protocols (Step S104). The network element may receive a redirect message in response to the transmitted modified content request message (Step S106). The redirect message may include redirect data that indicates to device 12 one of the cache locations in system 10 (e.g., node cache 40, server cache 54) from which device 12 may download requested content, e.g., the redirect data identifies one of the cache locations storing the content. Alternatively, the redirect message may indicate device 12 to which the indicated content is to be transmitted. In particular, server 42 may transmit the redirect message to a cache location such that device 12 does not have to initiate downloading of indicated content from the cache location, e.g., the redirect message may cause the cache location transmit the indicated content to device 12 in response to receiving the redirect message from server 42. Of note, the term “download” as used herein refers generally to the receipt of content. The content can be downloaded in a format in which the content may be stored for a short term or long term by device 12, or downloaded in a format in which the content is “streamed”. The identified one of the cache locations may be geographically closer than the remaining cache locations or nodes. The network element may transmit the redirect message to device 12 according to network communication protocols (Step S108). For example, the transmitted modified content request message may be received at server 42 in which server 42 generates the redirect message that is transmitted to device 12 via one or more network elements, as discussed in detail with respect to FIG. 4. Alternatively, the redirect message may not be received by one or more of the network elements the performed the enrichment process, e.g., the redirect message is routed or forwarded to device 12 or cache location via a different path along packet core 18 based network.

An exemplary redirect process for geo-locating device 12 to a cache location is described with reference to FIG. 4. Server 42 receives a modified content request message (Step S110). Server 42 evaluates the modified content request message to determine identification data (Step S112). Server 42 may determine whether identification data includes at least one cache location (Step S114). For example, the identification data may include one or more cache locations that stores various content. Each cache location in the packet core 18 based network may be indicated in the identification data by a respective URL or by other character strings capable of identifying a cache location. If server 42 determines that the identification data does not include cache locations, a determination is made whether the identification data includes an identity of at least one node (Step S116). For example, the identification data may include an IP address corresponding to one or more nodes in the packet core 18 based network, e.g., IP address of node 14, S-GW56 and/or P-GW 70. Other character strings capable of identifying at least one node may be used. If the identification data does not include the identity of at least one node, the redirect process may end, device 12 may be redirect to a default cache location located in content network 18 or a network administrator may be notified.

If the identification data includes the identity of at least one network element, server 42 determines cache locations (Step S118). In particular, server 42 interrogates the at least one network element to determine cache data indicating whether the at least one node has a cache location. The at least one network element may include P-GW 70, S-GW 56 and/or node 14, among other nodes, servers and gateways in packet core 18 based network. Interrogation of a network element may include requesting information from the network element via an interrogation message such that the network element transmits the requested information back to server 42 in response to interrogation message. For example, identification data identifies node 14a, node 14b and P-GW 70 by respective IP addresses in which server 42 may utilize the IP addresses to interrogate node 14a, node 14b and P-GW 70 to determine respective cache information. Server 42 interrogates node 14a to determine cache information in which the cache information indicates whether node 14a has a cache location or whether node 14a has a cache location storing the indicated content. Server 42 may interrogate some or all of the identified network elements to determine cache information. Server 42 may determine the one or more cache locations based at least in part on the cache information received from the interrogation.

Referring back to Step S114, if the identification data includes at least one cache location, server 42 determines cache locations based at least in part on the at least one cache location identified in the identification message (Step S120). Server 42 may determine whether the determined at least one cache location stores the indicated content (Step S122). In particular, server 42 may interrogate the determined at least one cache location for cache information indicating whether the at least one cache location stores the indicated content. For example, server 42 interrogates determined cache locations at node 14a, node 14b and P-GW70 to determine whether the cache locations store the indicated content, e.g., whether the cache locations store the content requested by device 12. Alternatively, Step S122 may be skipped such that server 42 does not interrogate the cache locations to determine whether the cache locations actually store the indicated content. In particular, server 42 may determine the cache locations likely to have the indicated content (not shown). For example, server 42 may determine that certain cache locations are more active than other cache locations during a predefined period. Server 42 may determine the cache locations likely to have the indicated content based on previously transmitted redirect messages, redirect messages are discussed in detail with respect to Step S126. Other criteria may be used by server 42 to determine the likelihood of a cache location storing the requested content.

Server 42 determines the cache location geographically closest to the requesting device (Step S124). For example, server 42 may determine the geographic network topology of the determined cache locations relative to device 12. The network topology may be determined based at least in part on the ordering or layering of identification data in modified content request message received at server 42. In particular, server 42 may determine that identification data at the bottom of the identification data stack corresponds to a network element logically closest to device 12, e.g., identification data at the bottom of the identification stack was inserted by a network element logically closer to device 12 than the network element that inserted identification data at the top of the identification stack. The logical location of the network elements in the network may correspond to geographical location such that the logically closest location is also the geographically closest location. Continuing the example, node 14a and S-GW 56a may be determined to have cache locations storing the indicated content in which server 42 maps the geographic network topology of node 14a, S-GW 56a and device 12. Server 42 may determine that node 14a is the closest cache location storing the indicated content based at least in part on the geographic network topology. The network topology may be based at least in part on one or more network element IP addresses and/or one or more internet distance estimation algorithms that allow server 42 to generate the network topology of network elements corresponding to identification data.

Server 42 may push the indicated content to the geographically closest cache location. For example, server 42 may transmit the indicated content to the geographically closest cache location if Step S122 has been skipped, as noted above. In particular, server 42 determines the geographically closest cache location likely having the indicated content in which pushing the indicated content ensures the cache location has the indicated stored. The indicated content may be pushed to the cache location with the redirect message that is discussed below.

After server 42 determines the geographically closest cache location to device 12, server 42 generates a redirect message (Step S126). In particular, the redirect message may include redirect data that identifies the geographically closest cache location. For example, the redirect data may include a URL corresponding to the geographically closet cache location or may include an IP address of the network element having the geographically closest cache location. Server 42 may transmit the redirect message to device 12 such that the redirect message directs device 12 to the geographically closest cache location storing the indicated content, e.g., device 12 downloads the indicated content from the geographically closest cache location (Step S128).

An exemplary content request process for facilitating geo-location of device 12 to a cache location is described with reference to FIG. 5. Device 12 may initiate the content request process by generating and transmitting a content request message (Step S130). For example, user of device 12 may press an input button on device 12 that causes device 12 to generate and transmit a content request message. The content request message may indicate specific content that to be downloaded to device 12, e.g., video content to be downloaded. In response to the transmitted content request message, device 12 may receive a redirect message (Step S132). In particular, the redirect message may include redirect data that indicates a specific cache location or network element having the specific cache location. For example, the redirect data may include a URL corresponding to the specific cache location that is located geographically closest to device 12. Device 12 may download the indicated content from the specific cache location based at least in part on the redirect data (Step S134). Alternatively, redirect data may include the IP address of the mobile device or other identifying device information such that the specific cache location receives the redirect message and transmits the indicated content to device 12 based on the redirect data.

An exemplary example of system 10 for facilitating geo-location of device 12 to a cache location is described with reference to FIG. 6. In particular, several cache locations are located through system 10. For example, server 42a has cache location C1, P-GW 70 has cache location C2, S-GW 56 has cache location C3, node 14a has cache location C4, node 14b has cache location C5 and node 14n has cache location C6. Cache location C1 is located in the content network, i.e., outside the EPC based network, while cache locations C2 to C6 are located within packet core 18 based network. Device 12 may be a mobile device 12 operating on mobile networks 84a to 84n (collectively referred to as “mobile network 84”). In particular, mobile device 12 may be assigned an IP address at time one (“time 1”) while mobile device 12 is in mobile network 84b. Mobile device 12 may be handed-off from node 14b to node 14n while continuing to use the same IP address, e.g., at time two (“time 2”) mobile device 12 may be handed-over during a communication session. For example, a user may be using mobile device 12 while traveling along a highway such that mobile device 12 may be handed-off among several base stations or nodes 14, among other network elements. A single communication session of mobile device 12 may be handed-off several times to different mobile networks while maintaining the initially assigned IP address.

At time 2, mobile device 12 may generate and transmit a content request message to content network 18a requesting the specific content. The content request message may be modified by the enrichment process at least once before reaching network 18a, as discussed with respect to FIG. 3. The modified content request message may be received at server 42a such that server 42a determines the geographically closest cache location to mobile device 12 storing the indicated content. In particular, cache locations C1 to C6 may all store the indicated content in which server 42a determines that cache location C6 is the geographically closest cache location to mobile device 12. Had mobile device 12 been handed-over to mobile network 84a at time 2, server 42 would have determined that the geographically closest cache to mobile device 12 would be cache location C4 even though mobile device 12 was still using the initially assigned IP address, e.g., the IP address that corresponds a mobile device 12 being served by node 14b. Accordingly, server 42a is able to geo-locate mobile device 12 to the geographically closest cache location storing the requested or indicated content, irrespective whether mobile device 12 has been hand-over one or more times.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A network element in a network, the network element comprising:
a receiver, the receiver receiving a content request message indicating content to be transmitted to a device;
a processor in communication with the receiver, the processor:
generating a modified content request message by inserting identification data into the content request message, the identification data identifying at least one of a plurality of network nodes in the network;
a transmitter, the transmitter transmitting the modified content request message to a content distribution network server; and
the receiver further receives a redirect message that is based on the transmitted modified content request message, the redirect message identifying that a one of the plurality of network nodes is a cache location storing the indicated content.

2. The network element of claim 1, wherein the identified one of the plurality of network nodes is geographically closer to the device than the remaining plurality of network nodes storing the indicated content.

3. The network element of claim 2, wherein the network element is one of the plurality of network nodes.

4. The network element of claim 2, wherein the received content request message is generated by the device after the device was handed-over during a communication session.

5. The network element of claim 2, wherein the transmitter further transmits the redirect message to the device, the redirect message directing the device to the cache location at the indicated one of the plurality of network nodes.

6. The network element of claim 2, wherein the transmitter transmits the redirect message to the indicated one of the plurality of network nodes such as to cause the indicated one of the plurality of network nodes to transmit the indicated content to the device.

7. The network element of claim 1, wherein the identification data indicates at least one of cache locations and identities of the plurality of network nodes.

8. The network element of claim 7, wherein the identities of the plurality of network nodes are Internet Protocol (IP) addresses corresponding to the plurality of network nodes.

9. The network element of claim 7, wherein the cache locations store the indicated content, the cache locations being identified in the identification data by uniform resource locators (URLs) corresponding to the cache locations.

10. The network element of claim 7, wherein the identification data is inserted as an additional header in the content request message.

11. The network element of claim 7, wherein the received content request message is an already modified content request message that was previously modified by one of the plurality of network nodes.

12. A system, the system comprising:
a server, the server including:
a receiver, the receiver receiving a modified content request message indicating content to be transmitted to a device, the modified content request message including identification data corresponding to at least one network node in a network;
a processor in communication with the receiver, the processor:
evaluating the modified content request message to determine the identification data; and
determining a first cache location based at least in part on the identification data, the first cache location being a network node storing the indicated content, the first cache location being geographically closer to the device than other cache locations at other network nodes.

13. The system of claim 12, wherein the processor further generates a redirect message specifying the first cache location; and
the server further includes a transmitter in communication with the processor, the transmitter transmitting the redirect message to at least one of the device and first cache location.

14. The system of claim 12, wherein determining the first cache location comprises interrogating the at least one network node to determine whether the indicated content is stored in a cache of the corresponding network node.

15. The system of claim 12, wherein the network node includes:
a second receiver, the second receiver receiving the content request message indicating content to be transmitted to the device;
a second processor in communication with the second receiver, the second processor:
inserting identification data into the content request message to generate the modified content request message; and
a transmitter, the transmitter transmitting the modified content request message to the server.

16. The system of claim 12, wherein the identification data identifies at least one of a cache location and identities of the at least one node.

17. The system of claim 16, wherein the identities of the at least one node are Internet Protocol (IP) addresses corresponding to the at least one node.

18. The system of claim 16, wherein the first cache location stores the indicated content, the cache location being designated in the identification data by a uniform resource locator (URL).

19. The system of claim 16, wherein the network is an Evolved Packet Core (EPC) based network, the server being positioned logically outside the EPC based network.

20. A method for geo-locating a device to a cache location, the method comprising:
receiving a content request message indicating content to be transmitted to a device;
generating a modified content request message by inserting identification data into the content request message, the identification data corresponding to at least one node in the network;
transmitting the modified content request message; and
forwarding a redirect message generated in response to the transmitted modified content request message, the redirect message directing the device to one of a plurality of cache locations storing the indicated content, the direction being based at least in part on geographic location.

21. The method of claim 20, wherein the one of the plurality of cache locations is geographically closer to the device than the remaining plurality of cache locations.

22. The method of claim 20, further comprising:
receiving the modified content request message;
evaluating the modified content request message to determine identification data;
determining one of the plurality of cache locations based at least in part on the identification data, the determined one of the plurality of cache locations storing the indicated content; and
generating the redirect message identifying the determined one of the plurality of cache locations.

23. The method of claim 22, further comprising interrogating the at least one node, the interrogation providing cache location data.

24. The method of claim 22, wherein the indicated content is cached at the one of the plurality of cache locations based at least in part on a frequency at which the indicated content has been previously requested.

25. The method of claim 24, wherein other content requested less than the indicated content is stored at one of the plurality of cache locations geographically further than the determined one of the plurality of cache locations.

26. The method of claim 25, wherein the network is an Evolved Packet Core (EPC) based network, at least a portion of the other content being stored logically outside the EPC based network.

27. The method of claim 26, wherein the identification data indicates at least one of cache location and identity of the at least one node.

28. The method of claim 27, wherein the at least one cache location stores the indicated content, the at least one cache location being identified in the redirect message by a uniform resource locator (URL).
